(19) United States
(12) Patent Application Publication
(10) Pub. No.: US 2003/0006359 A1
(43) Pub. Date: Jan. 9, 2003

(54) Method and apparatus for stabilizing a signal

(75) Inventors: Vittorio Tenca, Caprino Veronese (VR) (IT); Ernesto Zanotti, S. Giovanni Lupatoto (VR) (IT); Andrea Bari, Verona (IT); Corrado Carradori, Pescantina (VR) (IT)

Correspondence Address: Christa Hildebrand, Norris, McLaughlin & Marcus, 220 E 42nd St, New York, NY, 10017, US

(73) Assignee: PWB-Ruhlatec Industrieprodukte GmbH, Seebach (DE)

(21) Appl. No.: 10/191,259

(22) Filed: Jul. 8, 2002

(30) Foreign Application Priority Data
Jul. 9, 2001 (DE) 101 32 540.1-32

(51) Int. Cl. G01J 1/32

(52) U.S. Cl. 250/205

(57) ABSTRACT

A method and apparatus are described for stabilizing optical signals that are generated by an LED and are converted into a voltage in a receiver, by returning a voltage signal derived from the receiver to the voltage supply of the LED, with the voltage signal being compared with a reference voltage, wherein when the returned voltage is lower than the reference voltage, the LED input voltage is increased and, conversely, when the returned voltage is greater than the reference voltage, the LED input voltage is decreased.

### BACKGROUND OF THE INVENTION

1. Field of the Invention

The present invention relates to a method for stabilizing a signal for optical sensors which are combined into a sensor/emitter unit with an LED and a timing disk/timing ruler. The invention also relates to a device for carrying out the method that includes an LED, timing disk/timing ruler and a receiver unit.

2. Description of the Related Art

It is known to supply the signal received by a receiver of a sensor-emitter unit to an amplifier and to compare the signal with a reference voltage (see FIG. 1). With this conventional device, the analog signal supplied by the receiver is converted to a square wave signal (digitized). However, the signal cannot be equalized, smoothed or normalized.

It is important in many applications that the signal coming from the receiver has a uniform amplitude height and a uniform separation between edges. This requirement can only be realized with complex and hence expensive optical sensors. Moreover, the signal form can also vary due to frequency variations and aging effects, so that measurement errors can arise for the following reasons:

1. Mechanical, optical, physical-electrical differences between the LEDs,

2. Effects caused by the support and construction of the LED,

3. Smoothness of the surface and accuracy of the support of the timing disk,

4. Aging effects,

5. Variations in the clock frequency.

### SUMMARY OF THE INVENTION

It is an object of the present invention to improve the aforedescribed properties of optical sensors and to provide a method wherein a stable signal can be obtained from the receiver of the sensor-emitter unit even when the clock frequencies change or the LEDs and sensors age, or due to variations introduced in the manufacturing process. An apparatus should also be provided which can stabilize the signals of optical sensors under the typical operating conditions by using simple inexpensively components.

The object is solved in that a voltage signal derived from a receiver is returned to the voltage supply of a LED, with the voltage signal being compared with a reference voltage, wherein when the returned voltage is lower than the reference voltage, the LED input voltage is increased and, conversely, when the returned voltage is greater than the reference voltage, the LED input voltage is decreased. Thus, it has been found that the signal of the LED can be stabilized with a relatively simple circuit (FIG. 2), namely a feedback loop. The apparatus of the invention is made of only a few simple electronic components that can be easily connected to conventional or already existing optical sensors (FIG. 3).

The new method is characterized in that the signal E1 from the receiver 2 of the sensor is compared with a reference voltage R1 before being supplied to the input of an amplifier 3, wherefrom a difference voltage U7 is formed, which is returned via a feedback line 9 and via a storage device 8 to the input of the amplifier 3, that the difference voltage U7 is supplied to a second amplifier 4 and compared therein with a second reference voltage R2, which second reference voltage is generated by adding the difference voltage U7 to a reference voltage derived from the LED 5, and that the signal 6 of the amplifier 4 that is obtained from the comparison with the second reference voltage R2 is used as a control signal for stabilizing the sensor signal E1.

Further a device for stabilizing a signal of optical sensors which are interconnected into a sensor-emitter unit together with an LED 5 and a timing disk/timing ruler 11, characterized in that the line 1 of the receiver of the sensor 2 is connected with the first input of an amplifier 3, with the second input of the amplifier connected to a reference source R1, wherein the output 7 of the amplifier is, on one hand, returned via a feedback line 9 and a capacitor 8 to the first input of the amplifier 3 and, on the other hand, connected to the first input of a second amplifier 4, with the second input of the second amplifier connected to a reference voltage source R2, and that the output line 6 of the second amplifier 4 is connected to a control unit 12 for the stabilized sensor signal.

Other objects and features of the present invention will become apparent from the following detailed description considered in conjunction with the accompanying drawings. It is to be understood, however, that the drawings are intended solely for purposes of illustration and not as a definition of the limits of the invention, for which reference should be made to the appended claims.

### BRIEF DESCRIPTION OF THE DRAWINGS

In the drawings, wherein like reference numerals delineate similar elements throughout the several figures, is shown in

FIG. 1 an optical sensor representing the state-of-the-art;

FIG. 2 a sensor according to the invention with LED feedback;

FIGS. 3a and 3b an encoder constructed according to the invention;

FIG. 4 a schematic block circuit diagram for signal processing with a feedback circuit according to the invention; and

FIGS. 5a-5e various curve forms observed during signal stabilization.

### DETAILED DESCRIPTION OF THE PRESENTLY PREFERRED EMBODIMENTS

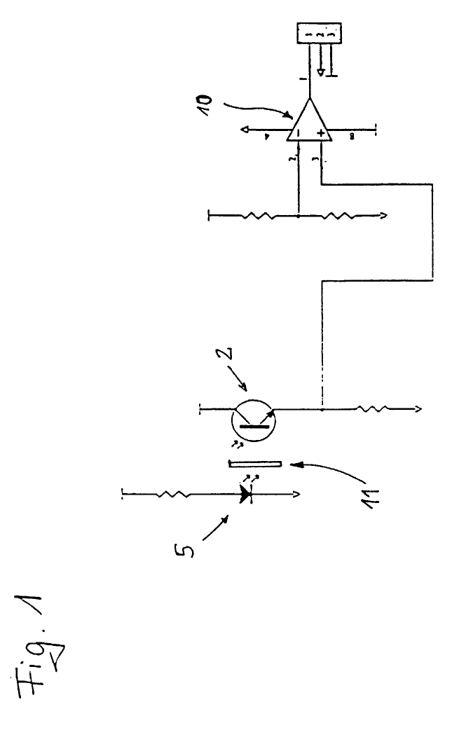

A conventional optical sensor is illustrated in FIG. 1, wherein the LED operates independent of the receiver unit. The signal coming from the receiver is supplied to the positive input terminal of an amplifier. A reference voltage is supplied to the negative input terminal of the amplifier. With this circuit, the amplitude height of the signal can be adjusted by adjusting the reference voltage. However, this circuit does not stabilize the frequency and phase of the signal. Instead, the signal is converted from analog to digital by a comparator or amplifier 10. The analog signal on the input pin 3 becomes a digital one on the output pin 1.

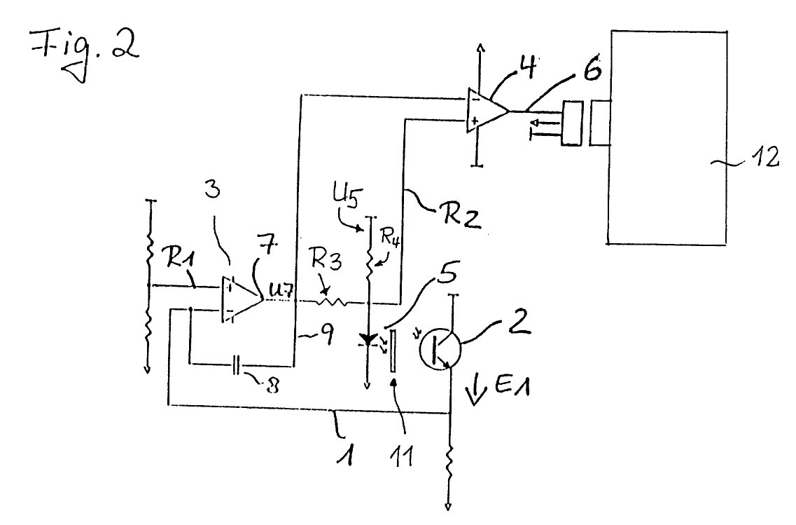

FIG. 2 depicts the circuit according to the invention for stabilizing the optical sensor. The line coming from the receiver is connected to the negative terminal of the amplifier, while the positive terminal is connected to the reference voltage. The difference between the reference voltage and the voltage obtained from the receiver is returned to the LED via a resistor R3. As is known in the art; a dropping resistor R4 is connected in series with the LED, with the resistance value of the dropping resistor in this embodiment increased from 220 ohm to 1200 ohm. In this way, current can be supplied to the LED under normal operating conditions via the line 7 of the first amplifier.

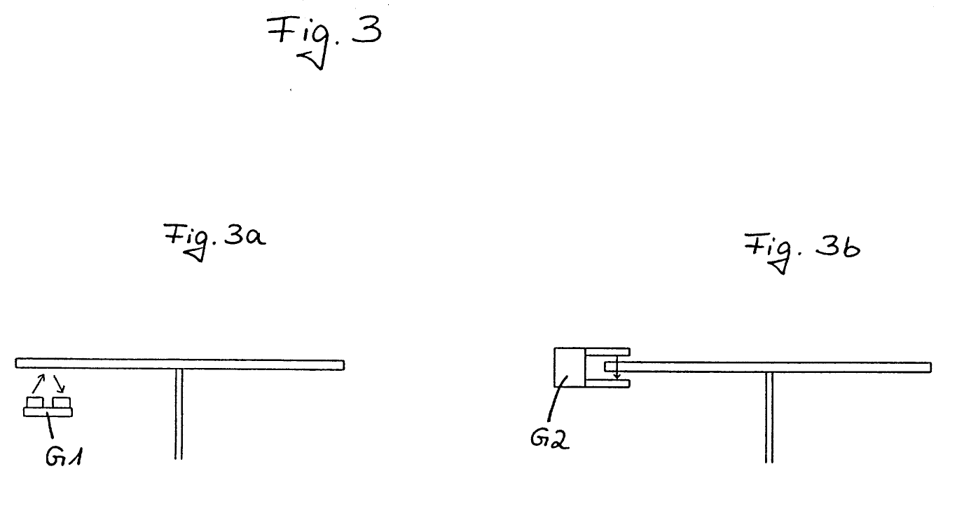

FIG. 3 illustrates the components of the novel encoder. FIG. 3a shows an encoder with a reflective layer, whereby the LED and the photo detector are arranged on the same side of the timing disk. This circuit according to the invention for stabilizing the signal is located on the base plate G1.

FIG. 3b shows the encoder with a transparent timing disk. The LED and the photo detector are arranged on opposite sides of the timing disk. This circuit according to the invention for stabilizing the signal is located on the base plate G2.

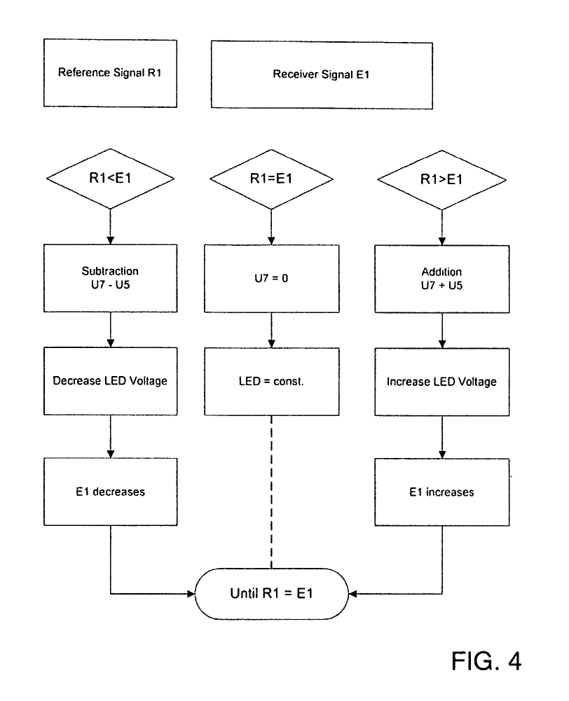

The different situations for stabilizing the signal can be described with reference to the block circuit diagram of FIG. 4. Herein, a reference signal R1 according to FIG. 2 and a receiver signal E1 supplied by the sensor unit are compared. In the simplest case, R1=E1, the voltage output of the amplifier is equal to U7=0. This means that the LED voltage is constant and that no change is detected.

However, if the receiver signal E1 is weak, then the reference voltage R1 is greater than E1 and a positive output signal is produced, so that U7 is added to the voltage U5. This increases the LED voltage, so that the intensity of light source increases. As a result, the receiver signal E1 increases until R1=E1.

Conversely, where the reference signal R1 is a smaller than the receiver signal E1, the voltage U7 produced by the amplifier is negative and is subtracted from the voltage U5. As a result, the LED voltage is decreased, so that the intensity of the limited light also decreases. Subsequently the receiver signal E1 also decreases until R1=E1.

The aforedescribed embodiment of the method can be augmented by additional steps. For example, it may be advantageous for stabilizing the signal to return the output signal of the amplifier U7 to the negative input terminal of the amplifier via a storage unit. The storage unit can preferably be implemented in form of one or more capacitors connected in parallel.

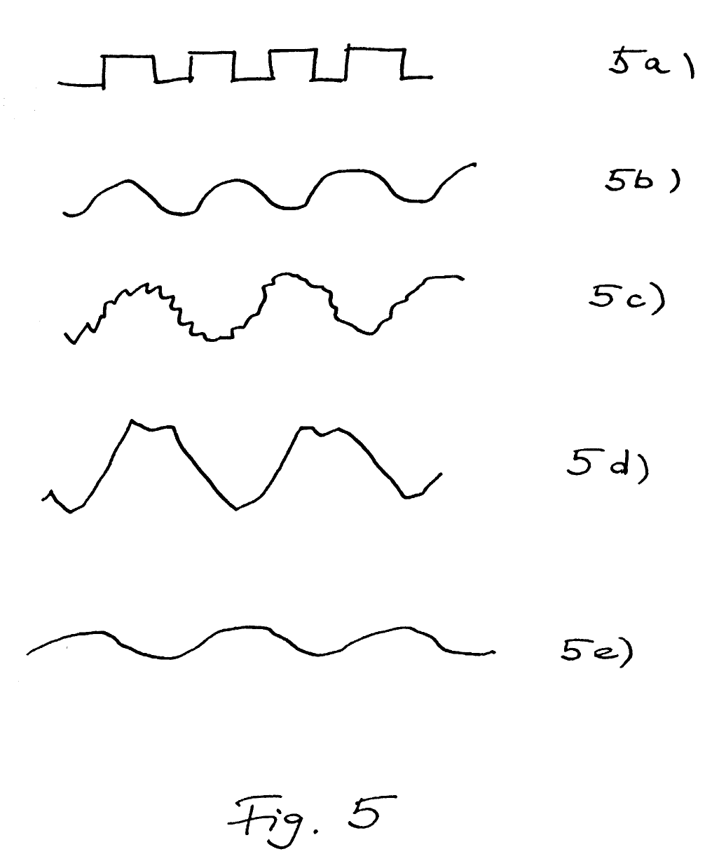

In an alternative embodiment, an amplifier or transistor circuit can be employed, wherein the output of the first amplifier and the LED voltage are connected to the positive-negative input terminals of a second amplifier. With this circuit, a sinusoidal curve in form of a square wave is obtained (see FIG. 5a).

Without the circuit of the invention for stabilizing the signal, a signal represented by the lower curve of FIG. 5b would be obtained. This signal form represents the present state-of-the-art and exhibits distortions distributed along the curve. A frequency variation and change in amplitude caused by aging can be illustrated in a compressed form. Irregularities in the mechanical section of the encoder or in the reflective zones of the timing disk cause strong variations in the amplitude and in the frequency of the receiver signal. These factors are illustrated schematically in FIG. 5c below. In FIG. 5d the curve represents a signal which will be obtained if the current into the LED is too high or the photo transistor/optical sor is too sensitive. A signal like in FIG. 5e will be obtained if the current into the LED is too low or the photo transistor/optical sensor has a low sensibility.

Thus, while there have been shown and described and pointed out fundamental novel features of the invention as applied to a preferred embodiment thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps that perform substantially the same function in substantially the same way to achieve the same results, are within the scope of the invention. Substitutions of elements from one described embodiment to another are also fully intended and contemplated. It is also to be understood that the drawings are not necessarily drawn to scale but that they are merely conceptual in nature. It is the intention, therefore, to be limited only as indicated by the scope of the claims appended hereto.

What is claimed is:

1. A method for stabilizing optical signals that are generated by an LED and are converted into a voltage in a receiver, comprising the steps of
returning a voltage signal derived from the receiver to the voltage supply of the LED, with the voltage signal being compared with a reference voltage, wherein when the returned voltage is lower than the reference voltage, the LED input voltage is increased and, conversely, when the returned voltage is greater than the reference voltage, the LED input voltage is decreased.

2. The method according to claim 1, wherein the comparison is performed in a difference amplifier.

3. The method according to claim 1, further comprising the step of
arranging a dropping resistor downstream of the difference amplifier in current direction, wherein a resistance value of the dropping resistor is selected so that when the voltage is negative, no additional voltage is introduced into the LED voltage source, and wherein when the voltage difference is positive, the voltage of the LED voltage source is increased by the corresponding positive voltage value.

4. A method for stabilizing optical sensors which are interconnected into a sensor-emitter unit together with an LED and a timing disk/timing ruler, comprising the steps of
comparing the signal (E1) from a receiver (2) of the sensor with a reference voltage (R1) before being supplied to the input of an amplifier (3), wherefrom a difference voltage (U7) is formed, which is returned via a feedback line (9) and via a storage device (8) to the input of the amplifier (3),
supplying the difference voltage (U7) to a second amplifier (4) and compared therein with a second reference voltage (R2), which second reference voltage is generated by adding the difference voltage (U7) to a reference voltage derived from the LED (5); and
using the signal (6) of the amplifier (4) that is obtained from the comparison with the second reference voltage (R2) as a control signal for stabilizing the sensor signal.

5. A device for stabilizing a signal of optical sensors which are interconnected into a sensor-emitter unit together with an LED (5) and a timing disk/timing ruler, comprising
a line (1) of a receiver of a sensor (2) being connected with a first input of an amplifier (3), with a second input of the amplifier connected to a reference source (R1), wherein a output (7) of the amplifier is, on one hand, returned via a feedback line (9) and a capacitor (8) to the first input of the amplifier (3) and, on the other hand, connected to the first input of a second amplifier (4), with the second input of the second amplifier connected to a reference voltage source (R2), and an output line (6) of the second amplifier (4) being connected to a control unit for the stabilized sensor signal.
